(19) United States
(12) Patent Application Publication
(10) Pub. No.: US 2005/0064756 A1
(43) Pub. Date: Mar. 24, 2005

(54) Cable connector assembly

(75) Inventors: Yu-Chien Hsiao, Guei Shan (TW); Wen-Wei Su, Guei Shan (TW); Kuei-Hung Chen, Guei Shan (TW)

Correspondence Address: TROXELL LAW OFFICE PLLC, SUITE 1404, 5205 LEESBURG PIKE, FALLS CHURCH, VA, 22041, US

(73) Assignee: Exon Science Incorporation

(21) Appl. No.: 10/724,716

(22) Filed: Dec. 2, 2003

(30) Foreign Application Priority Data
Sep. 22, 2003 (TW) 092217002

(51) Int. Cl. H01R 13/627

(52) U.S. Cl. 439/357

(57) ABSTRACT

An electrical connector assembly includes a first electrical connector and a second electrical connector mating with said first electrical connector. The first electrical connector includes a first dielectric housing, a number of first terminals received in the first dielectric housing, a latch extending from the first housing and a retaining device. The latch includes a hook portion for locking with said second electrical connector and a pressing portion for being exerted on by an external force. The pressing portion and the first dielectric housing define a space therebetween. And, the retaining device includes a main body moveably received in said space.

### BACKGROUND OF THE PRESENT INVENTION

### Field of the Invention

The present invention relates to a cable connector assembly, and more particularly to a cable connector assembly used in vehicles.

Recently, more and more electrical devices have been installed in vehicles for performing multiple function. Some electrical devices, such as a rearview mirror having anti-glaring function, an electrical compass installed in a dielectric housing of the rearview mirror or the headlamps installed in the rearview mirror, need power and signal connections with the other parts of the control system of the vehicle for achieving predetermined functions.

A cable assembly is generally employed for inputting/outputting power and signals for these electrical devices. U.S. Pat. No. 4,646,210 discloses a conventional cable assembly comprising two cable end connectors respectively connected to the rearview mirror and a power device of the vehicle so that the power can be transmitted from the battery to the rearview mirror. The cable connector assembly is fixed beside a pivotal hinge of the rearview mirror. However, the cable connector assembly is exposed outside and is inelegant for appearance for suit in the limousines.

U.S. Pat. Nos. 2,414,223 and 4,883,349 each disclose a cable received in a hollow hinge of the rearview mirror for solving the above-mentioned problems. However, due to the limited space in the hollow hinge, a cable connector assembly can not be placed in the hinge. So, in the prior arts, most of the cable connector assemblies are located at the inside surface of the roof of the vehicle.

Please referring now to FIG. 1 and FIG. 2, cables 82, 92 are fixed between the top of the vehicle and a flannelette layer to avoid being exposed outside. The cable 82, which is connected to a power source of the vehicle, is connected to the cable 92, which is connected to a rearview mirror, by a connector assembly. The connector assembly comprises a male connector 8 and a female connector 9 mated with each other. The female connector 9 has a latch 91 extending therefrom. When the male connector 8 and female connector 9 are mated together, a hook in front of the latch 91 will received in a corresponding portion of the male connector 8 for securing two matched connectors 8, 9. When these two connectors 8, 9 are required to be disconnected, a pressing portion 93 of the latch 91 is pressed downwardly and the hook of the latch 91 is separated from the corresponding portion of the male connector 8 to disconnect the two connectors 8, 9.

Because the connector assembly is parallel to the inside surface of the roof of the vehicle, even under the normal usag, the pressing portion 93 of the latch 91 may be compressed by unexpected force to cause the latch 91 of the female connector 9 to be disconnected from the male connector 8, thereby adversely affect an electrical connection between the connectors 8 and 9. Furthermore, due to the vibration of the vehicle, the above-mentioned condition may become even worse and the connectors 8 and 9 are disconnected permanently.

Therefore, there is a requirement for providing an improved cable connector assembly for ensuring a reliable electrical connection between two matched connectors.

### SUMMARY OF THE PRESENT INVENTION

It is an object of the present invention for providing a cable connector assembly having means for preventing two matched connectors from disconnecting unexpectedly.

Other objects, advantages and novel features of the present invention will be drawn from the following detailed description of preferred embodiments of the present invention with the attached drawings.

In order to achieve the above-mentioned object, an electrical connector assembly in accordance with the present invention comprises a first electrical connector and a second electrical connector for matching with the first electrical connector. The first electrical connector includes a first dielectric housing, a plurality of first terminals received in the first dielectric housing, a latch extending from the first housing and a retaining device. The latch includes a hook portion for locking with the corresponding portion on the second connector and a pressing portion for being exerted on when disconnection the connectors are under expecting. The pressing portion and the first dielectric housing define a space therebetween. The retaining device includes a main body moveably received in the space.

### BRIEF DESCRIPTION OF THE DRAWINGS

FIG. 1 is a side view of a conventional cable connector assembly before assembled onto a top position of a vehicle;

FIG. 2 is a cross-section view of the connector assembly of FIG. 1 after assembled onto the top position of the vehicle;

FIG. 3 is an exploded perspective view of a cable connector assembly in accordance with a first embodiment of the present invention;

FIG. 4 is a side view of a female connector in FIG. 3 before a tie is assembled thereto;

FIG. 5 is an assembled perspective view of the cable connector assembly in FIG. 3;

FIG. 6 is a view showing the tie assembled to the female connector of FIG. 5;

FIG. 7 is a perspective view of the cable connector assembly of FIG. 5 with the tie disassembled therefrom;

FIG. 8 is a perspective view of a female connector of a cable connector assembly in accordance with a second embodiment of the present invention;

FIG. 9 is a view showing a moveable latch sliding through a frame of the female connector; and

FIG. 10 is a perspective view of a female connector of a cable connector assembly in accordance with a third embodiment of the present invention.

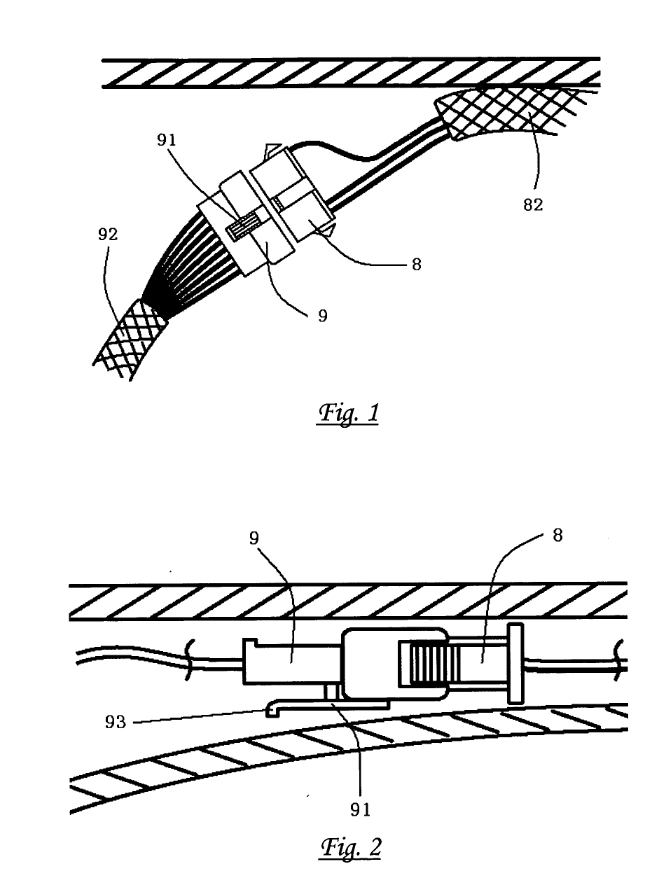

### PREFERRED EMBODIMENT OF THE PRESENT INVENTION

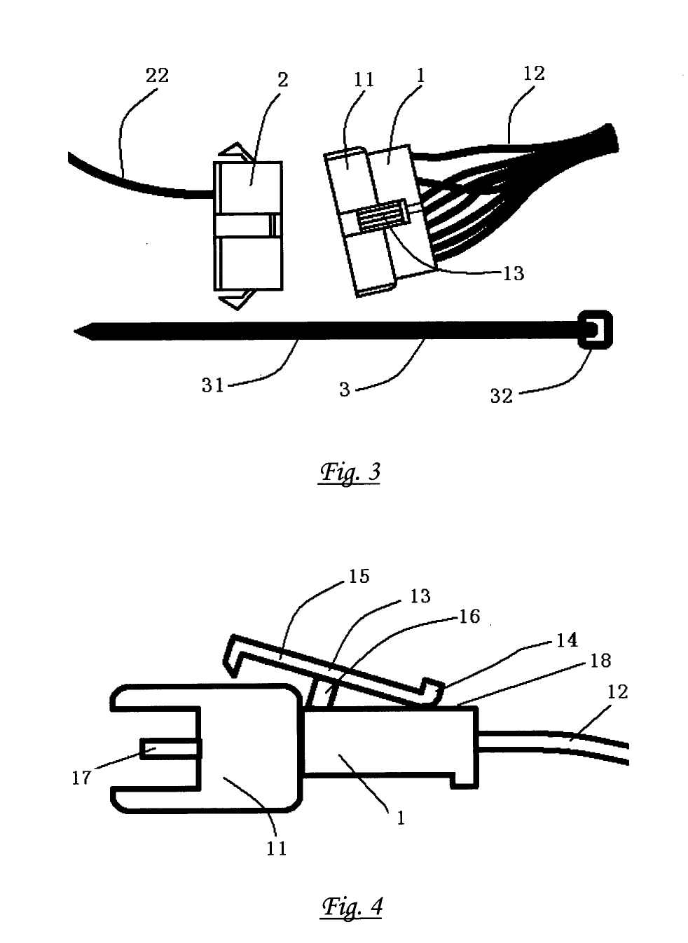

Referring to FIG. 3, a cable connector assembly in accordance with a first embodiment of the present invention comprises a female connector 1, a male connector 2, a tie 3 and cables 12, 22 respectively connecting with the male and the female connectors 1, 2. The tie 3 is made of plastic material and comprises a main portion 31 with serration formed thereon and a locking portion 32 at one end of the main portion 31. The tie 3 has a structure substantially the same as the tie used in the art, the detailed description is omitted herein.

Referring to FIG. 4, the female connector 1 comprises a dielectric housing 11, and a plurality of terminals 17 received in the housing 11. The terminals 17 are electrically connecting with a cable 12. The housing 11 has a latch 13 integrally formed on a top thereof. The latch 13 includes a support 16 integrally extending from the housing 11, a hook 15 formed on a front portion of the latch 13 and adapted for latching with a recess (not shown) of the male connector 2, and a pressing portion 14 formed on a rear portion of the latch 13. Before the tie 3 is assembled to the female connector 1, the pressing portion 14 can be pressed downwardly to actuate the hook 15 to separated from the recess of the male connector 2, whereby the female connector 1 can be disconnected from the male connector 2.

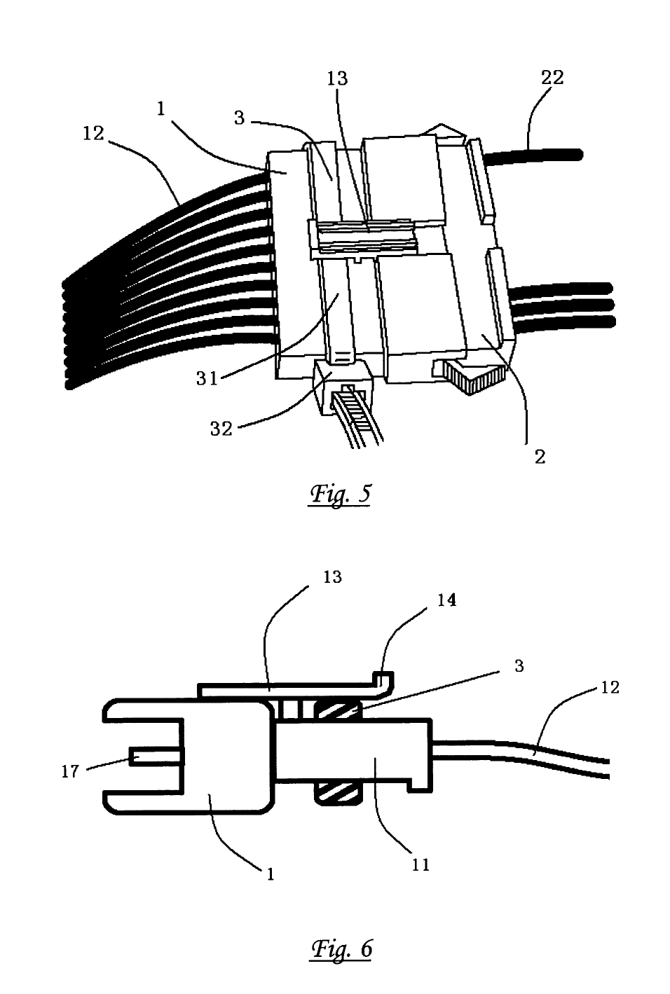

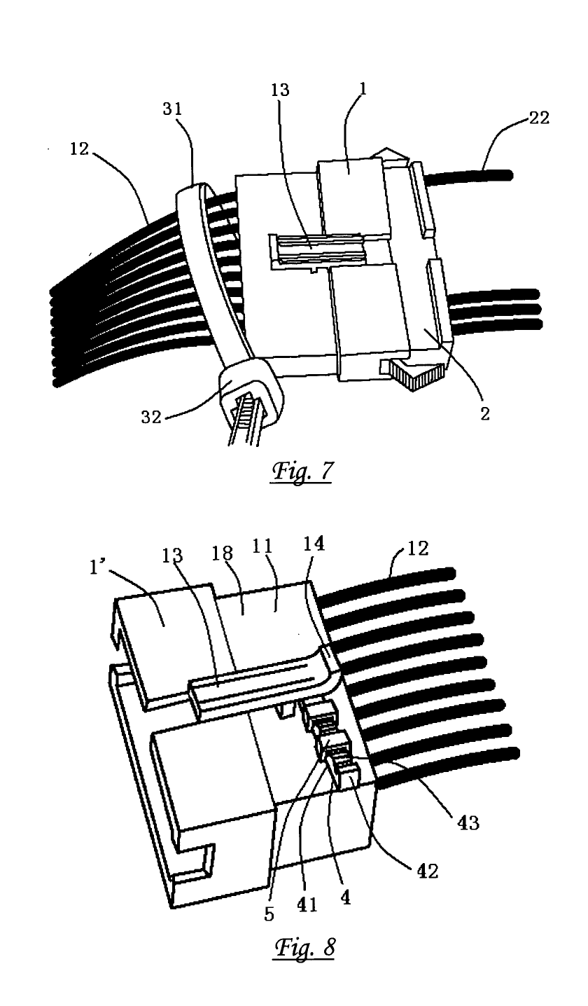

Referring to FIGS. 5 and 6, the tie 3 is wrapped around the dielectric housing 11 of the female connector 1 with the main portion 31 extending through the locking portion 32 to secure the tie 3 on the female connector 1. The thickness of the main portion 31 is substantially equal to the height of the space between the pressing portion 14 of the latch 13 and a top surface 18 of the dielectric housing 11. Therefore, the main portion 31 of the tie 3 is sandwiched between the pressing portion 14 and the dielectric housing 11. When the pressing portion 14 is subject to a downward external force, the pressing portion 14 will not move downwardly and the hook 15 will not be actuated to separate from the recess of the male connector 2, thereby ensuring a reliable electrical and mechanical connection between the female connector 1 and the male connector 2. Please continuing to FIG. 7, when the two connectors 1, 2 are required to be disconnected from each other, the tie 3 is first broken away from the space between the pressing portion 14 of the latch 13 and a top surface 18 of the dielectric housing 11, the pressing portion 14 is then can be pressed downwardly to allow the two connector 1, 2 to be separated from each other.

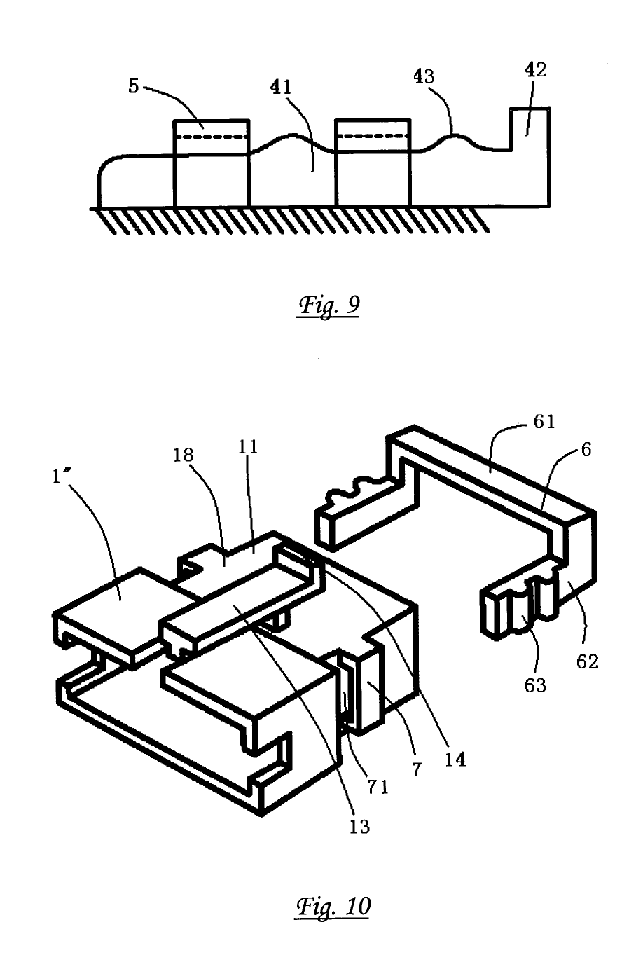

Referring to FIGS. 8 and 9, a female connector 1 in accordance with a second embodiment of the present invention has a structure substantially the same as the female connector 1 of the first embodiment except that the dielectric housing 11 of the female connector 1 defines a pair of door-shaped frames 5 on a top surface 18 thereof for a moveable block 4 extending therethrough. The moveable block 4 includes an elongated main body 41 and a pull tab 42 at one end of the main body 41. The main body 41 is formed with a pair of ribs 43 on a top surface thereof. The main body 41 of the moveable block 4 passes through the pair of door-shaped frames 5 to be sandwiched between the pressing portion 14 and the dielectric housing 11. A thickness of the main body 41 is substantially equal to the height of the space between the pressing portion 14 and a top surface 18 the dielectric housing 11. A hole (not labeled) of the frame 5 has a height slightly larger than the thickness of the main body 41 but slightly smaller than the thickness of the ribs 43, whereby the moveable block 4 successfully passes through the frames 5 and is retained below the pressing portion 14 via an interferential engagement between the ribs 43 and the frames 5. Thus, the moveable block 4 is securely kept in a position below the pressing portion 14 of the latch 13. When the female connector 1 is required to be disconnected from the male connector 2, an external force is exerted on the pull tab 42 to actuate the moveable block 4 to move rearwardly. The main body 41 is thus broken away from the space between the pressing portion 14 and the dielectric housing 11 to allow the pressing portion 14 to be downwardly pressed, thereby disengaging the female connector 1 from the male connector 2.

Referring to FIG. 10, a female connector 1 in accordance with a third embodiment of the present invention has a structure substantially the same as the female connector 1, 1 of the first and second embodiments except that the dielectric housing 11 of the female connector 1 is formed with a pair of projecting ears 7 on opposite lateral sides (not labeled) thereof. A cavity 71 is defined between the projecting ears 7 and a corresponding lateral side of the dielectric housing 11. A clip 6 includes a lever 61 and a pair of arms 62 extending forwardly from opposite ends of the lever 61. Each arm 62 is formed with a pair of ribs 63 on a lateral side thereof. A thickness of the lever 61 is substantially equal to the height of the space between the pressing portion 14 of the latch 13 and the top surface 18 of the dielectric housing 11. The clip 6 is pushed forward to allow the arms 62 to be received in the cavities 71 of the projecting ears 7. The pair of ribs 63 of each arm 62 has an interference fit with a corresponding projecting ear 7 to retain the clip 6 to the projecting ear 7. At the same time, the lever 61 is sandwiched between the pressing portion 14 and the top surface 18 of the dielectric housing 11 to prevent the pressing portion 14 from moving downwardly by an unexpected force, thereby ensuring a reliable connection between the female connector 1 and the male connector 2.

It is noted that the two ribs 63 may have different heights, wherein one rib 63 which is adjacent the lever 61 has a height smaller than that of another rib 63, thereby enhancing a reliable engagement between the clip 6 and the projecting ears 7.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An electrical connector comprising:
a dielectric housing;
a plurality of terminals received in said housing;
a latch extending from the housing and comprising a locked portion for locking with a complementary connector and a pressing portion for being exerted on by an external force, the pressing portion and the dielectric housing defining a space therebetween; and
a retaining device comprising at least a main body moveably received in said space.

2. The electrical connector as claimed in claim 1, wherein the locked portion of the latch is a hook adapt for being received in a recess of the complementary connector.

3. The electrical connector as claimed in claim 1, wherein the retaining device is a tie wrapped around the housing, and the tie comprises a main portion with a plurality of serrations formed thereon and a locking portion at one end of the main portion, the main portion having a segment received in the space.

4. The electrical connector as claimed in claim 3, wherein the thickness of the main portion of the tie is substantially equal to the height of the space between the pressing portion and the dielectric housing.

5. The electrical connector as claimed in claim 1, wherein the housing defines at least one frame on a top surface from which the latch extends, and the retaining device comprises a main body and a pull tab at one end of the main body, the main body passing through the at least one frame and received in the space between the pressing portion and the dielectric housing, the thickness of the main body being substantially equal to a height of the space.

6. The electrical connector as claimed in claim 5, wherein the main body of the retaining device is formed with at least one rib, and the at least one frame each defines a cavity having a height slightly larger than a thickness of the main body but slightly smaller than the thickness of the rib.

7. The electrical connector as claimed in claim 6, wherein the at least one rib includes two ribs, and the at least one frame includes two frames, one of the two ribs which is adjacent the pull tab having a height smaller than the other rib.

8. The electrical connector as claimed in claim 1, wherein the housing is formed with a pair of projecting ears at opposite sides thereof, and each projecting ear defines a cavity therein, the retaining device including a lever received in the space between the pressing portion and the housing and a pair of arms extending forwardly from the lever and retained in the cavities of the projecting ears, the thickness of the lever being substantially equal to a height of the space.

9. The electrical connector as claimed in claim 8, wherein each arm of the retaining device is formed with at least one rib to have an interferential engagement with a corresponding projecting ear.

10. The electrical connector as claimed in claim 9, wherein the at least one rib includes two ribs, one of the two ribs which is adjacent the lever having a height smaller than that the other rib.

11. The electrical connector as claimed in claim 1, wherein the latch comprises a support integrally extending from the housing, and the locked portion and the pressing portion are respectively located at opposite sides of the support.

12. An electrical connector assembly comprising:
a first electrical connector comprising:
a first dielectric housing;
a plurality of first terminals received in the first dielectric housing;
a latch extending from the first housing and comprising a hook portion for locking with a complementary connector and a pressing portion for being exerted on by an external force, the pressing portion and the first dielectric housing defining a space therebetween; and
a retaining device comprising a main body moveably received in the space; and
a second electrical connector mating with said first electrical connector, comprising:
a second dielectric housing defining a recess for receiving said hook portion of the latch; and
a plurality of second terminals received in the second dielectric housing.

13. The electrical connector assembly as claimed in claim 12, wherein the retaining device is a tie wrapped around the first housing, and the tie comprises a main portion with a plurality of serrations formed thereon and a locking portion at one end of the main portion, the main portion having a segment for received in the space.

14. The electrical connector assembly as claimed in claim 13, wherein a thickness of the main portion of the tie is substantially equal to a height of the space between the pressing portion and the first dielectric housing.

15. The electrical connector assembly as claimed in claim 12, wherein the first housing defines at least one frame, and the retaining device comprises a main body and a pull tab at one end of the main body, the main body passing through the at least one frame to be received in the space between the pressing portion and the first dielectric housing, a thickness of the main body being substantially equal to a height of the space.

16. The electrical connector assembly as claimed in claim 15, wherein the main body of the retaining device is formed with at least one rib, and the at least one frame each defines a cavity having a height slightly larger than a thickness of the main body but slightly smaller than a thickness of the rib.

17. The electrical connector assembly as claimed in claim 16, wherein the at least one rib includes two ribs, and the at least one frame includes two frames, one of the two ribs which is adjacent the pull tab having a height smaller than the other rib.

18. The electrical connector as claimed in claim 12, wherein the first housing is formed with a pair of projecting ears at opposite sides thereof, and each projecting ear defines a cavity therein, the retaining device including a lever received in the space between the pressing portion and the first housing and a pair of arms extending forwardly from the lever and retained in the cavities of the projecting ears, a thickness of the lever being substantially equal to a height of the space.

19. The electrical connector as claimed in claim 18, wherein the at least one rib includes two ribs, one of the two ribs which is adjacent the lever having a height smaller than the other rib.

20. The electrical connector as claimed in claim 12, wherein the latch comprises a support integrally extending from the first housing, and the hook portion and the pressing portion are respectively located at opposite sides of the support.
